(19) United States
(12) Patent Application Publication
(10) Pub. No.: US 2020/0230723 A1
(43) Pub. Date: Jul. 23, 2020

(54) BLOWER FOR CIRCULAR SAW

(71) Applicant: Black & Decker Inc., New Britain, CT (US)

(72) Inventor: Kelly E. DYER, Takoma Park, MD (US)

(21) Appl. No.: 16/840,914

(22) Filed: Apr. 6, 2020

Related U.S. Application Data
(63) Continuation of application No. 13/917,210, filed on Jun. 13, 2013.

(51) Int. Cl. B23D 59/00; B23Q 11/12; B23Q 11/00

(52) U.S. Cl. CPC B23D 59/006; B23Q 11/005; B23Q 11/127

(57) ABSTRACT

A saw may include a housing, a motor assembly, a fan and a baffle. The motor assembly may be disposed within the housing and may include a driveshaft that is rotatable relative to the housing. The fan may be attached to a first end portion of the driveshaft for rotation with the driveshaft. The baffle may be disposed within the housing and may include a recess and a chute in communication with the recess. The fan may be disposed within the recess and may force air through the recess and into the chute. The chute may extend tangentially from a body of the baffle and may include a shape that curves around a rotational axis of the fan as the chute curves away from a plane in which the fan rotates.

### CROSS-REFERENCE TO RELATED APPLICATIONS

This application is a continuation of U.S patent application Ser. No. 13/917,210 filed on Jun. 13, 2013. The entire contents of which are incorporated herein by reference.

### FIELD

The present disclosure relates to a circular saw having a blower.

### BACKGROUND

A motor-driven power tool, such as a circular saw, may include a fan that rotates with the motor to force air across one or more motor components to cool the motor. It may be desirable to channel the forced air to a location at or near a location at which a blade (or other cutting or material- removal tool) of the blade makes contact with a workpiece. In this manner, the forced air may blow saw dust, chips and/or other cuttings away from the location at which the blade makes contact with the workpiece to maintain a clearer line of sight of a cut line in the workpiece.

This section provides background information related to the present disclosure and is not necessarily prior art.

### SUMMARY

This section provides a general summary of the disclosure, and is not a comprehensive disclosure of its full scope or all of its features.

In one form, the present disclosure provides a saw that may include a housing, a motor, a fan and a blower housing. The housing may include first and second vents. The motor may be disposed within the housing and may include a stationary member and a rotatable member. The fan may be attached to the rotatable member and may be rotatable therewith relative to the housing. The blower housing may be disposed within the housing and may include a baffle and a plate. The baffle may include a stem, a body and a chute. The stem may engage the stationary member and may include an opening extending therethrough. The body may include a recess in communication with the opening and the chute. The fan may be rotatable within the recess. The plate may be fastened to the baffle to enclose the fan within the recess. The housing and the blower housing may cooperate to define an airflow pathway through which air is forced by the fan. The airflow pathway may extend from the first vent, between the stationary member and the rotatable member, and through each of the opening, the recess, the chute and the second vent.

In some embodiments, the chute may extend tangentially from the body.

In some embodiments, the chute may include a shape that curves around a rotational axis of the fan as the chute curves away from a plane in which the fan rotates.

In some embodiments, the stem, body and chute may cooperate to form a monolithic body that may be molded as a single piece.

In some embodiments, the saw may include a support member disposed within the housing and supporting a first end of the rotatable member for rotation relative to the housing. The stationary member may be sandwiched between and may directly contact the baffle and the support member.

In some embodiments, the saw may include a plurality of fasteners that directly engage the baffle and directly engage the support member.

In some embodiments, the saw may include a blade driven by the motor. An outlet of the chute and the second vent may face a location that is radially outward relative to a radially outer cutting edge of the blade.

In some embodiments, the fan may be disposed at a first axial end of the motor and the first vent may be disposed adjacent a second axial end of the motor.

In another form, the present disclosure provides a saw that may include a housing, a motor assembly, a fan, a support member and a baffle. The motor assembly may be disposed within the housing and may include a stator, a rotor and a driveshaft. The rotor and the driveshaft may be rotatable relative to the stator and the housing. The fan may be attached to a first end portion of the driveshaft for rotation with the driveshaft. The support member may be disposed within the housing and may support a second end portion of the driveshaft for rotation relative to the housing. The support member may fixedly engage a first axial end of the stator. The baffle may be disposed within the housing and may engage a second axial end of the stator. The baffle may include a recess in which the fan is disposed and a chute in communication with the recess. The fan may force air through the recess and into the chute.

In some embodiments, the support member may be fixed relative to the housing.

In some embodiments, the baffle may be spaced apart from the support member and a plurality of fasteners may engage the baffle and the support member to secure the baffle relative to the support member.

In some embodiments, the chute may extend tangentially from the body.

In some embodiments, the chute may include a shape that curves around a rotational axis of the fan as the chute curves away from a plane in which the fan rotates.

In some embodiments, the saw may include a baffle plate mounted to the baffle that encloses the fan within the recess.

In some embodiments, the baffle plate may include an integrally formed chute cover that mates with the chute and cooperates with the chute to define an airflow passageway.

In some embodiments, the housing may include a first vent disposed adjacent the support member and a second vent disposed adjacent an outlet of the chute.

In some embodiments, the housing and the baffle may cooperate to define an airflow pathway through which air is forced by the fan. The airflow pathway may extend from the first vent, between the stator and the rotor, and through the recess, the chute and the second vent.

In another form, the present disclosure provides a saw that may include a housing, a motor assembly, a fan and a baffle. The motor assembly may be disposed within the housing and may include a driveshaft that is rotatable relative to the housing. The fan may be attached to a first end portion of the driveshaft for rotation with the driveshaft. The baffle may be disposed within the housing and may include a recess and a chute in communication with the recess. The fan may be disposed within the recess and may force air through the recess and into the chute. The chute may extend tangentially from a body of the baffle and may include a shape that curves around a rotational axis of the fan as the chute curves away from a plane in which the fan rotates.

In some embodiments, the saw may include a baffle plate mounted to the baffle and enclosing the fan within the recess.

In some embodiments, the baffle plate may include an integrally formed chute cover that mates with the chute and cooperates with the chute to define an airflow passageway.

In some embodiments, the saw may include a support member disposed within the housing and supporting a first end of the driveshaft for rotation relative to the housing. A stator of the motor assembly may be sandwiched between and may directly contact the baffle and the support member.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a circular saw having a according to the principles of the present disclosure;

FIG. 2 is another perspective view of the circular saw of FIG. 1 with blade guards removed;

FIG. 3 is an exploded perspective view of the circular saw of FIG. 1;

FIG. 4 is a an exploded perspective view of a motor assembly and blower housing of the circular saw;

FIG. 5 is a side view of the motor assembly and blower housing of FIG. 4;

FIG. 6 is a top plan view of the circular saw;

FIG. 7 is a top plan view of the circular saw with an outer housing and blade guards removed;

FIG. 8 is a cross-sectional view of the circular saw taken through line 8-8 of FIG. 6; and

FIG. 9 is a cross-sectional view of the circular saw taken through line 9-9 of FIG. 6.

Corresponding reference numerals indicate corresponding parts throughout the several views of the drawings.

### DETAILED DESCRIPTION

Example embodiments will now be described more fully with reference to the accompanying drawings.

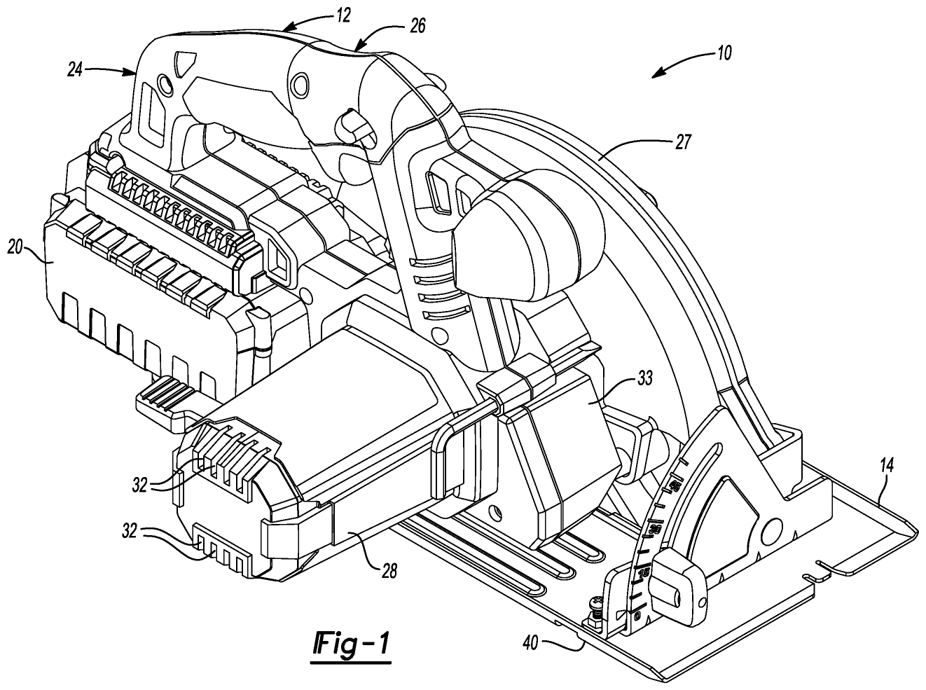

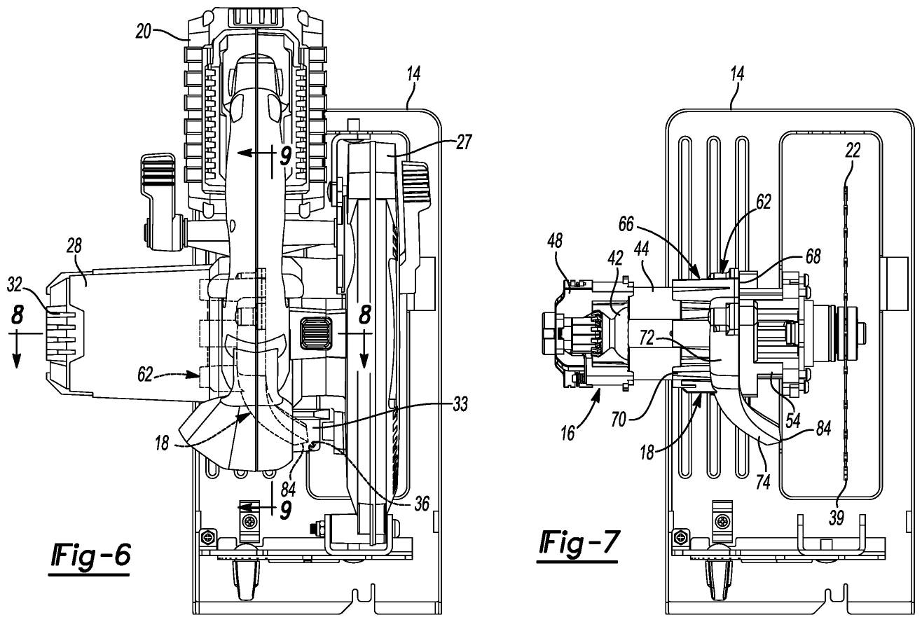

With reference to FIGS. 1-9, a circular saw 10 is provided that may include an outer housing 12, a shoe 14, a motor assembly 16 and a blower assembly 18. The motor assembly 16 may receive electrical current from a battery 20 and may drive a blade 22. It will be appreciated, however, that the circular saw 10 could be a plug-in saw, in which case the motor assembly 16 may receive electrical current from a power cord plugged into a wall outlet or a generator, for example. As will be subsequently described, the blower assembly 18 may be operable to generate a flow of air and direct the flow of air to a location at or near the blade 22 to blow saw dust, chips and/or other cuttings away from a location at which the blade 22 contacts a workpiece during operation of the circular saw 10.

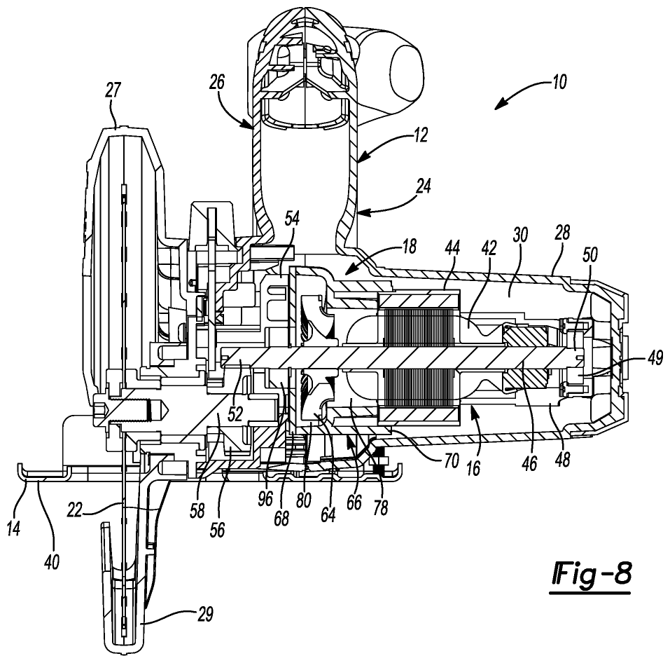

The outer housing 12 may include a first shell portion 24 and a second shell portion 26 that cooperate to enclose the motor assembly 16 and blower assembly 18. Upper and lower blade guards 27, 29 may be attached the outer housing 12 and may partially enclose the blade 22. The first shell portion 24 may include a motor housing 28 that defines a first cavity 30 (FIG. 8) in which at least a portion of the motor assembly 16 is disposed. A distal end of the motor housing 28 may include one or more first vent openings 32 through which air from the ambient environment may be drawn into the first cavity 30.

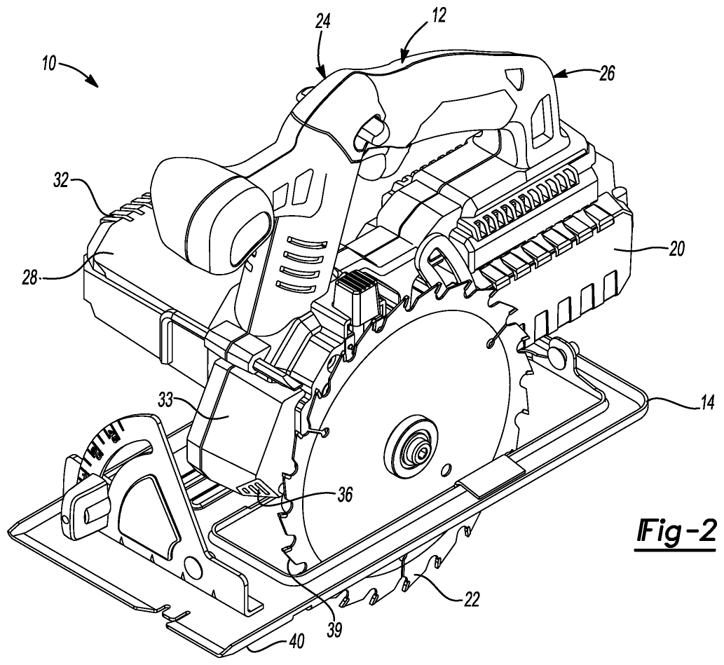

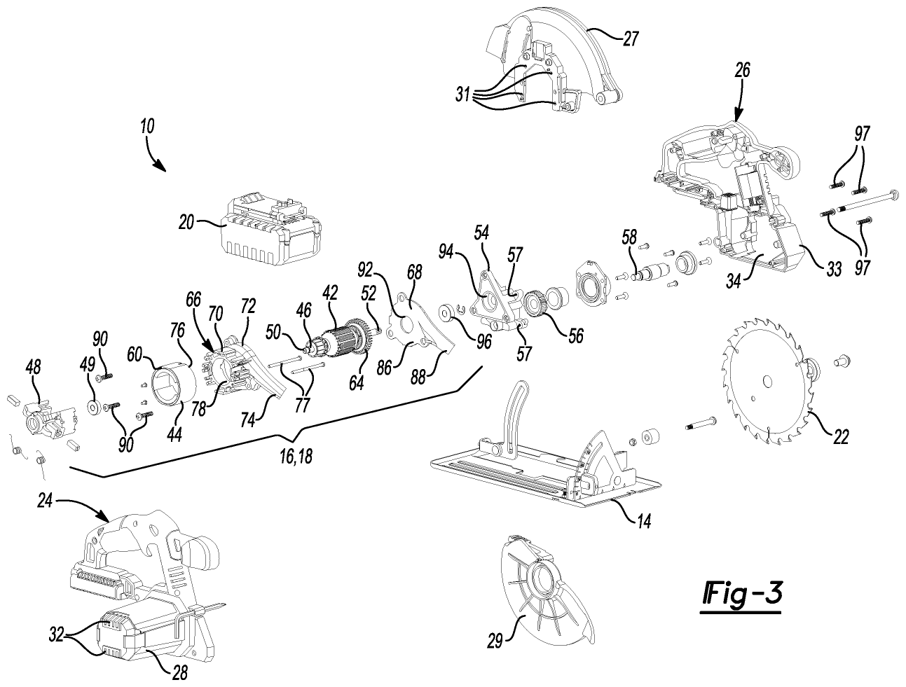

The second shell portion 26 includes a lower portion 33 defining a second cavity 34 (FIG. 3) and one or more second vent openings 36 (FIGS. 2 and 6). The second cavity 34 is in communication with the first cavity 30 and the second vent openings 36. In this manner, air from the ambient environment is allowed to flow through the first vent openings 32 to the first cavity 30, into the second cavity 34 (via the blower assembly 18, as will be subsequently described), and exit through the second vent openings 36 to the ambient environment. The second vent openings 36 may be configured to direct air flowing therethrough to a location at or proximate an intersection between an outer radial edge 39 of the blade 22 and a plane defined by a bottom face 40 of the shoe 14.

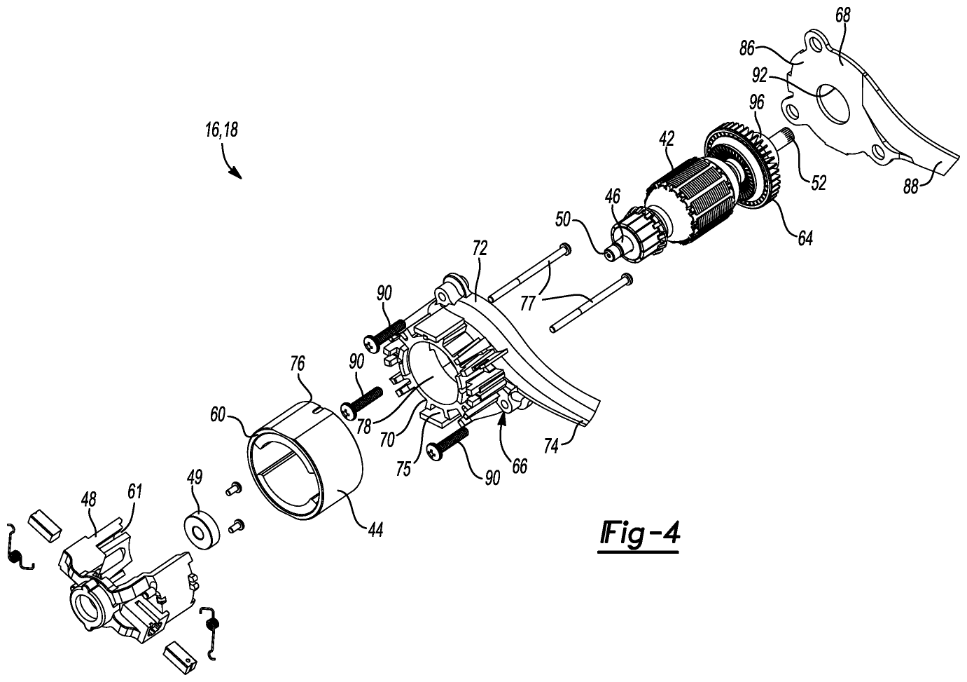

As shown in FIGS. 3-5, the motor assembly 16 may include a rotor or armature 42, a stator or magnet ring 44, a driveshaft 46, and a support member 48. The rotor 42 may be fixedly attached to the driveshaft 46 for rotation relative to the stator 44. The stator 44 may be coaxial with the driveshaft 46 and rotor 42 and may surround a portion of the driveshaft 46 and rotor 42. The support member 48 may be disposed within the first cavity 30 of the motor housing 28 and may house a bearing 49 (FIGS. 4 and 8) that supports a first end 50 of the driveshaft 46 for rotation relative to the motor housing 28 and stator 44. A gear case 54 (FIGS. 3, 7 and 8) fixed within the lower portion 33 of the second shell portion 26 may rotatably support a second end 52 of the driveshaft 46. The second end 52 of the driveshaft 46 may include gear teeth that meshingly engage a gear 56 (FIGS. 3 and 8) disposed within the gear case 54. The gear 56 may engage a shaft 58 that protrudes through the lower portion 33 of the second shell portion 26 and engages the blade 22. In this manner, rotation of the rotor 42 and driveshaft 46 is transmitted to the blade 22 through the gear 56 and shaft 58. The support member 48 may fixedly engage a first axial end 60 of the stator 44. In some embodiments, the first axial end 60 may be received in slots 61 (FIG. 4) of the support member 48.

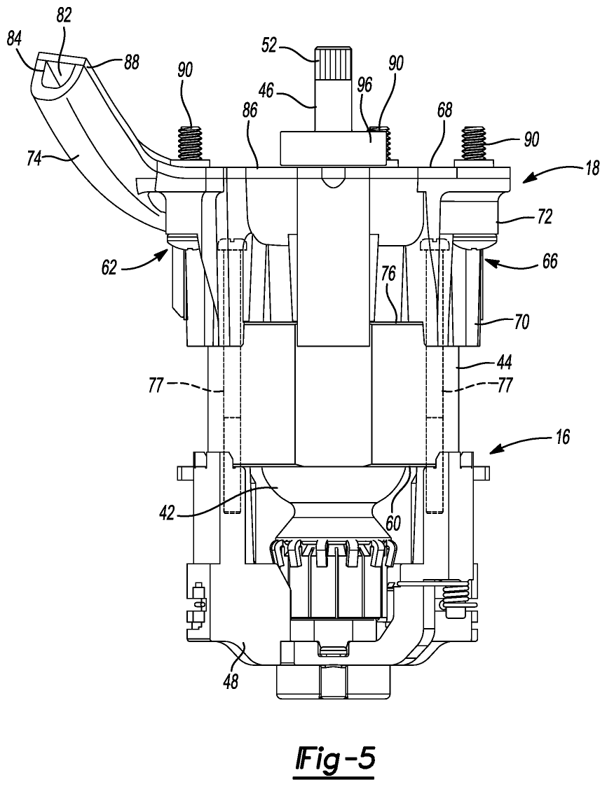

The blower assembly 18 may include a blower housing 62 and a fan 64 that is disposed within the blower housing 62 and is rotatable therein. The blower housing 62 may include a baffle 66 and a plate 68. As shown in FIGS. 4 and 5, the baffle 66 may include a stem portion 70, a body portion 72 and a chute 74. In some embodiments, the stem portion 70, body portion 72 and chute 74 may be integrally formed as a monolithic body. The stem portion 70 may fixedly engage a second axial end 76 of the stator 44 so that the stator 44 is sandwiched between the stem portion 70 and the support member 48, thereby fixing the stator 44 relative to the motor housing 28. In some embodiments, the second axial end 76 may be received in slots 75 (FIG. 4) of the stem portion 70.

As shown in FIG. 5, fasteners 77 may extend through bolt holes in the baffle 66 and through an inner opening of the stator 44 (e.g., the inner opening defined by the inner diameter of the stator 44) and threadably engage the support member 48. Tightening the fasteners 77 may clamp the stator 44 between the baffle 66 and the support member 48. As shown in FIG. 8, the stem portion 70 and the support member 48 support the stator 44 so that the stator 44 is spaced apart from the motor housing 28.

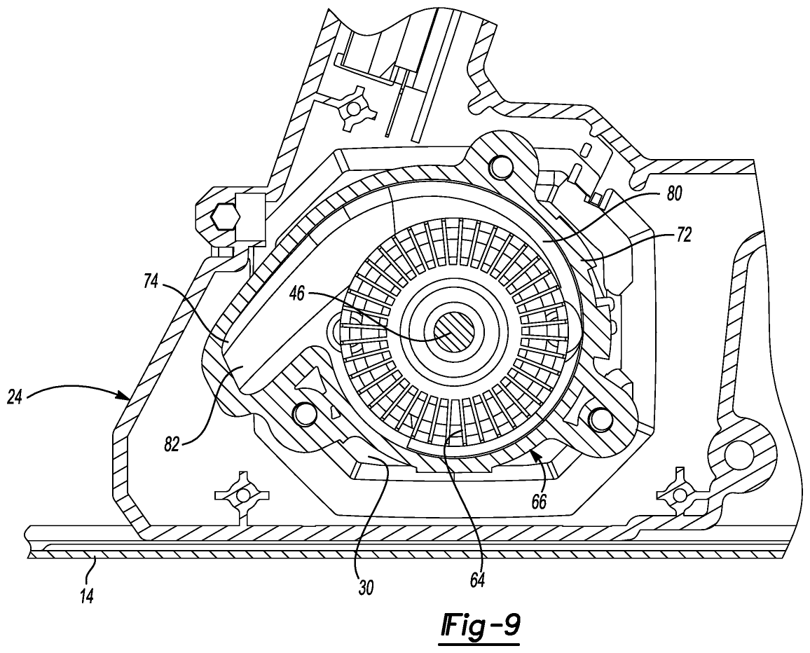

The stem portion 70 may include an opening 78 extending therethrough that may be coaxial with the stator 44 and driveshaft 46. The opening 78 may be in fluid communication with a recess 80 (FIGS. 8 and 9) formed in the body portion 72. The chute 74 may define a fluid passageway 82 that is in fluid communication with the recess 80 and extends tangentially outward from the recess 80 (as shown in FIG. 9). The chute 74 and passageway 82 may include a generally corkscrew or helical shape such that the chute 74 and passageway 82 curve around a rotational axis of the driveshaft 46 as the chute 74 and passageway 82 curve away from a plane in which the fan 64 rotates (as shown in FIGS. 5, 7 and 9). As shown in FIG. 6, an outlet 84 of the chute 74 may be disposed adjacent the second vent openings 36 so that air flowing through the passageway 82 is directed through the second vent openings 36.

The plate 68 may include a body portion 86 and a chute cover 88 integrally formed with and extending outward from the body portion 86. The plate 68 may be secured to the baffle 66 by a plurality of fasteners 90, for example, such that the body portion 86 substantially encloses the fan 64 within the recess 80 and the chute cover 88 cooperates with the chute 74 to define the passageway 82. The fasteners 90 may threadably engage the gear case 54, thereby fixing the blower housing 62 relative to the gear case 54. The body portion 86 includes an aperture 92 through which the driveshaft 46 extends. The aperture 92 may be aligned with an aperture 94 (FIG. 3) in the gear case 54 that houses a driveshaft bearing 96 rotatably supporting the second end 52 of the driveshaft 46.

Fasteners 97 (FIG. 3) may extend through apertures 31 in the upper blade guard 27 and threadably engage apertures 57 of the gear case 54. The upper blade guard 27 may be fixed to the second shell portion 26 by fasteners, for example, thereby fixing the gear case 54 relative to the second shell portion 26 and the upper blade guard 27.

The fan 64 may be fixed to the driveshaft 46 and may rotate within the recess 80. In this manner, when the motor assembly 16 is operating (i.e., when the rotor 42 and driveshaft 46 are rotating relative to the stator 44), the fan 64 will rotate with the driveshaft 46 and draw air through the first vent openings 32 and into the first cavity 30. From the first cavity 30, the fan 64 may draw the air in an axial direction between the stator 44 and rotor 42 (thereby cooling the stator 44 and rotor 42), through the opening 78, and into the recess 80. The fan 64 may force the air radially outward through the recess 80 and into the passageway 82 of the chute 74. The air is then forced through the passageway 82 and subsequently out of the outer housing 12 through the second vent openings 36. The air forced through the second vent openings 36 may blow saw dust, chips and/or other cuttings away from a location at which the blade 22 makes contact with a workpiece to maintain a clearer line of sight of the cut line that the user is making in the workpiece.

The shape and construction of the blower housing 62 described above provides an efficient airflow path from the first vent openings 32 to the second vent openings 36. That is, a stronger flow of air is provided through the second vent openings 36 while reducing the drag on the motor assembly 16. For example, providing the fan 64 in the recess 80 between the baffle 66 and the plate 68 helps the fan 64 eject the air in a radial direction to reduce unnecessary recirculation of the air within the motor housing 28. Further, the tangential transition between the recess 80 and the passageway 82 through the chute 74 and the generally corkscrew or helical shape of the passageway 82 reduces turbulence and efficiently delivers the air to the location proximate the blade 22. Furthermore, because the space between the stator 44 and the rotor 42 is a part of the airflow path between the first and second vent openings 32, 36, the airflow path provides the dual purposes of cooling the motor assembly 16 and removing saw dust, chips and/or other cuttings from the cut line during operation of the circular saw 10.

While the motor assembly 16 and blower assembly 18 are described above as being incorporated into a circular saw 10, it will be appreciated that the motor assembly 16 and blower assembly 18 could be incorporated into any other type of electric power tool, such as a jigsaw or a reciprocating saw (saber saw), for example. As such, the principles of the present disclosure are not limited to circular saws.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A saw comprising:
a housing having first and second vents;
a motor disposed within the housing and including a stationary member and a rotatable member;
a fan attached to the rotatable member and rotatable therewith relative to the housing;
a saw blade driven by the motor; and
a blower housing disposed within the housing and including a baffle and a plate, the baffle including a stem, a body and a chute, the stem engaging the stationary member and including an opening extending therethrough, the body including a recess in communication with the opening and the chute, the fan being rotatable within the recess, the plate being fastened to the baffle to enclose the fan within the recess,
wherein the housing and the blower housing cooperate to define an airflow pathway through which air is forced by the fan, the airflow pathway extending from the first vent, between the stationary member and the rotatable member, and through each of the opening, the recess, the chute and the second vent.

2. The saw of claim 1, wherein the chute extends tangentially from the body.

3. The saw of claim 2, wherein the chute includes a shape that curves around a rotational axis of the fan as the chute curves away from a plane in which the fan rotates.

4. The saw of claim 3, wherein the stem, body and chute cooperate to form a monolithic body.

5. The saw of claim 1, further comprising a support member disposed within the housing and supporting a first end of the rotatable member for rotation relative to the housing, wherein the stationary member is sandwiched between and directly contacts the baffle and the support member.

6. The saw of claim 5, further comprising a plurality of fasteners that directly engage the baffle and directly engage the support member.

7. The saw of claim 6, wherein the stationary member cooperates with the rotatable member to define an annular passageway, and wherein the fasteners extend through the annular passageway.

8. The saw of claim 5, wherein the support member receives a bearing that rotatably supports the driveshaft.

9. The saw of claim 1, further comprising a blade driven by the motor, wherein an outlet of the chute and the second vent face a location that is radially outward relative to a radially outer cutting edge of the blade.

10. The saw of claim 1, wherein the fan is disposed at a first longitudinal end of the motor and the first vent is disposed adjacent a second longitudinal end of the motor.

11. The saw of claim 1, wherein the stationary member is an annular member surrounding the rotatable member, and wherein the stationary member and the rotatable member cooperate to define an annular passageway through which the air flows in response to rotation of the fan.

12. A saw comprising:
a housing;
a motor assembly disposed within the housing and including a driveshaft that is rotatable relative to the housing;
a fan attached to a first end portion of the driveshaft for rotation with the driveshaft;
a saw blade driven by the motor through the driveshaft;
a baffle disposed within the housing and including a recess and a chute in communication with the recess, the fan being disposed within the recess and forcing air through the recess and into the chute, the chute extending tangentially from a body of the baffle and including a shape that curves around a rotational axis of the fan as the chute curves away from a plane in which the fan rotates;
a baffle plate mounted to the baffle and enclosing the fan within the recess;
a support member disposed within the housing and supporting a first end of the driveshaft for rotation relative to the housing, wherein a stator of the motor assembly is sandwiched between and directly contacts the baffle and the support member;
wherein the baffle abuts a first axial end of the stator and the support member abuts a second axial end of the stator, and wherein the stator includes a longitudinal axis extending between the first and second axial ends; and
wherein the baffle plate includes an integrally formed chute cover that mates with the chute and cooperates with the chute to define an airflow passageway.

13. The saw of claim 12, wherein the stator cooperates with a rotor of the motor assembly to define an annular airflow path in fluid communication with the recess.

14. The saw of claim 13, wherein the support member engages a bearing rotatably supporting the driveshaft.

15. The saw of claim 14, wherein the chute curves away from the plane in which the fan rotates in a direction opposite the motor assembly.

16. The saw of claim 15, wherein the baffle plate includes a body portion;
wherein the chute cover is integrally formed with the body portion; and
wherein the chute cover extends outwardly from the body portion.

17. The saw of claim 16, wherein the baffle plate is secured to the baffle by a plurality of fasteners.

18. The saw of claim 17, further comprising a gearcase fixed within the housing;
wherein the gear case supports the driveshaft.

19. The saw of claim 18, further comprising a gear disposed within the gear case;
wherein the driveshaft includes gear teeth;
wherein the gear teeth of the driveshaft meshingly engage the gear.

20. The saw of claim 19, wherein the plurality of fasteners engage the gear case.
